(19) United States
(12) Patent Application Publication
(10) Pub. No.: US 2018/0053332 A1
(43) Pub. Date: Feb. 22, 2018

(54) METHOD, DEVICE, AND SYSTEM FOR MARKING OBJECTS IN AN IMAGE AND RETRIEVING DETAILS OF THE OBJECTS FROM THE IMAGE

(71) Applicant: Rothschild Trust Holdings, LLC, Miami, FL (US)

(72) Inventor: Leigh Mitchell Rothschild, Miami, FL (US)

(73) Assignee: Rothschild Trust Holdings, LLC, Miami, FL (US)

(21) Appl. No.: 15/680,257

(22) Filed: Aug. 18, 2017

Related U.S. Application Data
(60) Provisional application No. 62/377,688, filed on Aug. 22, 2016.

(51) Int. Cl. G06T 11/60; G06T 7/70; H04N 5/232; G06K 9/62; G06F 17/30

(52) U.S. Cl. CPC G06T 11/60; G06T 7/70; G06F 17/30268; G06K 9/6201; H04N 5/23293

(57) ABSTRACT

A device, system and a method for marking objects present in an image and retrieving details of objects marked in the image is disclosed. The image is scanned to identify an object. The object comprises animate and inanimate things. Details of the object are retrieved by matching an identity of the object with pre-stored data tables. Metadata information of the image is updated to include the details of the object. Hotspot information of the object is embedded into the image, to include the details of the object. The image comprising the object is displayed. At least one section of the image is highlighted to indicate a user about presence of a hotspot in the section. Details of the object are presented to a user, based on a user input indicative of a selection of the input.

### FIELD OF THE DISCLOSURE

The present disclosure is generally related to image processing and more particularly to embedding information about objects in an image and using the embedded information.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In order to obtain information related to any place, thing, object, or person, it is always preferred to search on Internet. Search engines may be used to explore information available over the Internet. A user provides the search engine with a search query made up of keywords. Subsequently, the search engine gathers all relevant data related to the search query, available over the Internet, and presents the relevant information to the user.

Many a times, the user is unable to perform an effective search. This may happen because of inaccurate search query used by the user. This situation may result in collection of irrelevant information. Also, in certain situations, the user may not have enough time to collect information about his object of interest. For example, a person while driving a vehicle may not be able to obtain information about a monument that he passes by. He may need to park his car and then search for information related to the monument.

Thus, a method and system of obtaining information about any object of interest in an expedient manner is much desired.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an example embodiment, a method, device, and a system for marking objects present in an image is provided. The method comprises identifying an object present in an image by scanning of the image. The object comprises animate and inanimate things. The method further comprises retrieving details of the object by matching an identity of the object with pre-stored data tables comprising details of all objects. The method further comprises updating metadata information of the image to include the details of the object. The method further comprises embedding hotspot information of the object, into the image to include the details of the object.

In another example embodiment, a method, device and a system for retrieving details of objects marked in an image is provided. The method comprises displaying an image comprising an object on a display device. The method further comprises highlighting at least one section of the image to indicate a user about presence of a hotspot in the section of the image. The hotspot is associated with details of the object in the section of the image. The method further comprises presenting details of the object to a user. The details of the object are presented based on a user input indicative of a selection of the hotspot. The details of the object comprise at least one of a hyperlink, text, video, and audio.

Other methods, devices, and system features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e. g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of a network environment 100 for marking objects present in an image and retrieving details of objects marked in the image, according to an embodiment.

FIG. 2 illustrates a flowchart 200 of a method of marking objects present in an image and retrieving details of objects marked in the image, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Memory 108, 208, and 308 may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions.

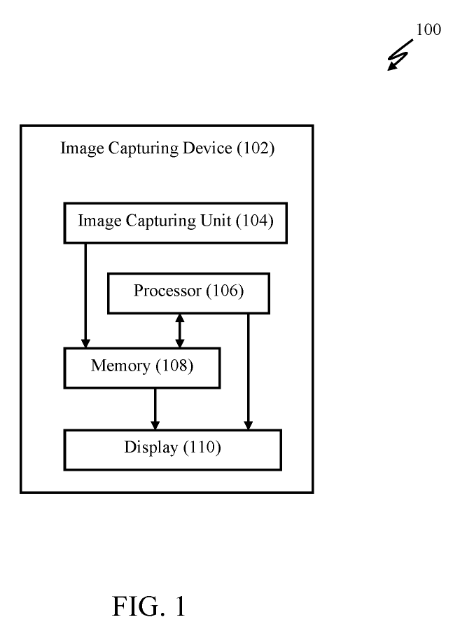

FIG. 1 illustrates a network environment 100 for marking objects present in an image, according to an embodiment. Current implementation uses an image capturing device 102 that may correspond to a standalone camera or devices comprising integrated cameras such as a laptop, tablet, cellular phone and similar others. The cellular phones may be running on operating systems such as Android™, IOS™, and Windows™.

In an embodiment, the image capturing device 102 may comprise an image capturing unit 104. The image capturing unit 104 may be a Charge Coupled Device (CCD) sensor or a Complementary Metal Oxide Semiconductor (CMOS) sensor. The image capturing unit 104 may capture an image of a view. The captured image may include associated metadata. The metadata may be present in any one of Extensible Metadata Platform (XMP), Exchangeable image file format (exif), Dublin core, Visual Resource Association (VRA) core, and Picture Licensing Universal System (PLUS) format.

In one embodiment, the metadata may comprise parameters associated with the image such as location information where the image is captured, image resolution, and other relevant details. Further, the metadata may comprise parameters associated with the image capturing device 102. The parameters may include zoom settings related to images, name and model, aperture size, ASA/ISO settings, and the like.

The image capturing device 102 further comprises a processor 106 coupled to a memory 108 for performing a series of functions. The image capturing device 102 may store the image in the memory 108. The image capturing device 102 may scan the image to identify an object present in the image. The image may be scanned using techniques selected from a group consisting but not limited to pixel to pixel recognition, hash based search, Hugh transform, and geometric consistency. The objects may comprise animate and inanimate things.

Successive to identification of the object, the image capturing device 102 may retrieve details of the object by matching an identity of the object with pre-stored data tables. The pre-stored data tables may be present in the memory 108 or on a remote server, and may comprise details of all animate and inanimate things.

In one embodiment, the object present in the image may be a building. The image capturing device 102 may perform an image match search in the pre-stored data tables, to match the identity of the building. Upon finding a successful match, the image capturing device 102 may be able to retrieve details of the building such as a name, location, address, number of floors, type (residential/ commercial), and a constructor of the building.

In another embodiment, the object present in the image may be an animal. The image capturing device 102 may perform a search to match image in the pre-stored data tables, to match the identity of the animal. Upon finding a successful match, the image capturing device 102 may be able to retrieve details of the animal such as a scientific name, breed, habitat, diet, and physical characteristics of the animal.

In yet another embodiment, multiple objects may be present in an image. For instance, a building, an animal, a tree, and a person may be identified by the image capturing device 102. Their identities may be matched in the pre-stored data tables. Upon finding successful matches for all the objects, the image capturing device 102 may retrieve their corresponding details.

Post retrieval of the details of the object, the image capturing device 102 may update the metadata of the image. The metadata may be updated to include details of the object. Successively, the image capturing device 102 may embed hotspot information on the object into the image to include the details of the object, thus marking the object present in the image.

In an alternate implementation, the image capturing device 112 may transmit the image to a remote server. The remote server may identify an object using any technique selected from or similar to pixel to pixel recognition, hash based search, Hugh transform, and geometric consistency. Further, the remote server may retrieve details of the object, update metadata information, and embed hotspot information in a similar manner as explained previously. Thus, the remote server may mark the object present in the image.

In one embodiment, the image comprising an object may be displayed on a display 110, by the processor 106. Successively, the processor 106 may highlight at least one section of the image to indicate a user about presence of a hotspot in the section of the image. The hotspot may be associated with details of the object in the section of the image. A user may select a hotspot from a highlighted section of the image. The user may select the hotspot using an input device, a voice recognition method, or other preferred device and method.

Based on the user input, details of the object may be presented to the user. The details of the object comprise at least one of a hyperlink, text, video, and audio. In one case, the object may be a book and the hyperlink may guide the user to a webpage guiding about content and cost of the book. In another case, the hyperlink may direct the user to an online e-commerce shopping portal for buying the book. Similarly, the text, audio and the video may also provide the user with information about the object.

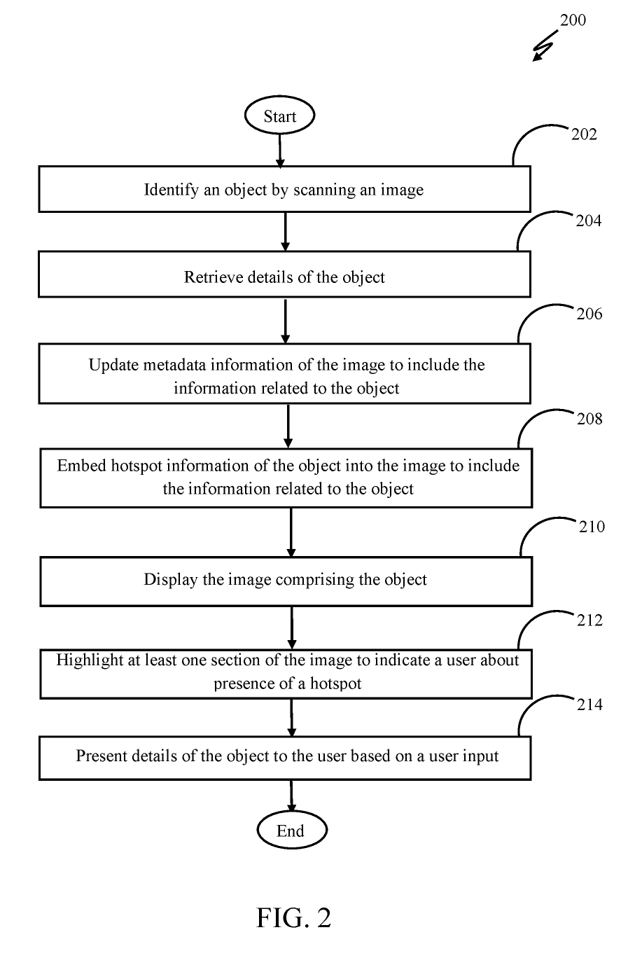

FIG. 2 illustrates a flowchart of a method of marking objects present in an image and retrieving details of objects marked in the image, according to an embodiment. FIG. 2 comprises a flowchart 200 that is explained in conjunction with the elements disclosed in FIG. 1.

The flowchart 200 of FIG. 2 shows the architecture, functionality, and operation for marking objects present in an image. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 200 starts at the step 202 and proceeds to step 214.

At step 202, an object present in an image may be identified by scanning the image. A scanning technique may be selected from a group consisting of but not limited to pixel to pixel recognition, hash based search, Hugh transform, and geometry consistency. The object may comprise animate and inanimate things.

At step 204, details of the object may be retrieved by matching an identity of the object with pre-stored data tables. The pre-stored data tables may comprise details of all animate and inanimate things. In one embodiment, the details of the object may be retrieved by the processors 106.

At step 206, metadata information of the image may be updated to include the details of the object. In one embodiment, the metadata information of the image may be updated by the processors 106.

At step 208, hotspot information of the object may be embedded into the image. The hotspot information may be embedded to include the details of the object. In one embodiment, the hotspot information of the object may be embedded by the processors 106.

At step 210, an image comprising an object may be displayed on a display. In one embodiment, the image comprising an object may be displayed by the processor 106.

At step 212, at least one section of the image may be highlighted to indicate a user about presence of a hotspot in the section of the image. The hotspot may be associated with details of the object in the section of the image. In one embodiment, the at least one section of the image may be highlighted by the processor 106.

At step 214, details of the object may be presented to a user. The details of the object may be presented based on a user input. The user input may be indicative of a selection of the hotspot. The details of the object may comprise at least one of a hyperlink, text, video, and audio. In one embodiment, the details of the object may be presented by the processor 106.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e. g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e. g., a modem or network connection).

What is claimed is:

1. A method of marking objects present in an image, the method comprising:
identifying, by a processor, an object present in an image by scanning the image, wherein the object comprises animate and inanimate things;
retrieving, by the processor, details of the object by matching an identity of the object with pre-stored data tables comprising details of all animate and inanimate things;
updating, by the processor, metadata information of the image to include the details of the object; and
embedding, by the processor, hotspot information of the object, into the image to include the details of the object.

2. The method of claim 1, wherein the object is identified using a scanning technique selected from a group consisting of pixel to pixel recognition, hash based search, Hugh transform, and geometry consistency.

3. The method of claim 1, wherein the processor is an integral unit of an image capturing device.

4. The method of claim 1, wherein the processor is an integral unit of a remote server.

5. A method of retrieving details of objects marked in an image, the method comprising:
displaying, by a processor, an image comprising an object on a display device, wherein the object comprises animate and inanimate things;
highlighting, by the processor, at least one section of the image to indicate a user about presence of a hotspot in the section of the image, wherein the hotspot is associated with details of the object in the section of the image; and
presenting, by the processor, details of the object to the user, wherein the details of the object are presented based on a user input indicative of a selection of the hotspot, and wherein the details of the object comprise at least one of a hyperlink, text, video, and audio.

6. The method of claim 5, wherein the processor is an integral unit of an image capturing device.

7. The method of claim 5, wherein the processor is an integral unit of a remote server.

8. The method of claim 5, further comprising transmitting the information related to the object to a user device.

9. A device for marking objects present in an image, the device comprising:
a processor configured to:
identify an object present in an image by scanning the image, wherein the object comprises animate and inanimate things;
retrieve details of the object by matching an identity of the object with pre-stored data tables comprising details of all animate and inanimate things;
update metadata information of the image to include the details of the object; and
embed hotspot information of the object, into the image to include the details of the object.

10. The device of claim 9, wherein the object is identified using a scanning technique selected from a group consisting of pixel to pixel recognition, hash based search, Hugh transform, and geometry consistency.

11. The device of claim 9, wherein the processor is an integral unit of an image capturing device.

12. The device of claim 9, wherein the processor is an integral unit of a remote server.

13. A device for retrieving details of objects marked in an image, the device comprising:
a processor configured to:
display an image comprising an object on a display device, wherein the object comprises animate and inanimate things;
highlight at least one section of the image to indicate a user about presence of a hotspot in the section of the image, wherein the hotspot is associated with details of the object in the section of the image; and
present details of the object to the user, wherein the details of the object are presented based on a user input indicative of a selection of the hotspot, and wherein the details of the object comprise at least one of a hyperlink, text, video, and audio.

14. The device of claim 13, wherein the processor is an integral unit of an image capturing device.

15. The device of claim 13, wherein the processor is an integral unit of a remote server.

16. The device of claim 13, further comprising transmitting the information related to the object to a user device.

17. A system for marking objects present in an image and retrieving details of the objects marked in the image, the system comprising
a processor configured to:
identify an object present in an image by scanning the image, wherein the object comprises animate and inanimate things;
retrieve details of the object by matching an identity of the object with pre-stored data tables comprising details of all animate and inanimate things;
update metadata information of the image to include the details of the object;
embed hotspot information of the object, into the image to include the details of the object;
display, on a display device, the image comprising the object;
highlight at least one section of the image to indicate a user about presence of a hotspot in the section of the image, wherein the hotspot is associated with details of the object in the section of the image; and
present details of the object to the user, wherein the details of the object are presented based on a user input indicative of a selection of the hotspot, and wherein the details of the object comprise at least one of a hyperlink, text, video, and audio.

18. The system of claim 17, wherein the processor is an integral unit of an image capturing device.

19. The system of claim 17, wherein the processor is an integral unit of a remote server.
